(19) United States
(12) Patent Application Publication
(10) Pub. No.: US 2011/0115454 A1
(43) Pub. Date: May 19, 2011

(54) VOLTAGE REGULATOR

(76) Inventors: Melvin K. Benedict, Magnolia, TX (US); Reza M. Bacchus, Houston, TX (US)

(21) Appl. No.: 12/936,674

(22) PCT Filed: Apr. 8, 2008
(86) PCT No.: PCT/US08/59635

§ 371 Date: Oct. 6, 2010

(51) Int. Cl. G05F 1/46

(52) U.S. Cl. 323/282

(57) ABSTRACT

A voltage regulator is provided that includes current sense circuitry configured to detect an amount of current provided to a load, a voltage controlled oscillator configured to output a clock signal with a constant duty cycle at a frequency that varies in dependence on the amount of current detected by current sense circuitry, and regulator circuitry configured to provide a regulated voltage to the load using the clock signal.

### BACKGROUND

Voltage regulators typically provide a regulated voltage to a load using a reference voltage and a supply voltage. Voltage regulators operate to provide the regulated voltage at as constant of a voltage level as possible regardless of the amount of current drawn by the load or the operating frequency of the load. Depending on the design of a voltage regulator, the power efficiency of a regulator may not be optimal for all operating conditions of a load. It would be desirable to be able to operate a voltage regulator with optimal power efficiencies for various operating conditions of a load.

### BRIEF DESCRIPTION OF THE DRAWINGS

FIG. 1 is a block diagram illustrating one embodiment of a voltage regulator with an efficiency tracking function.

FIG. 2 is a flow diagram illustrating one embodiment of a method for operating a voltage regulator with an efficiency tracking function.

FIG. 3 is a block diagram illustrating one embodiment of a processing system that includes a voltage regulator with an efficiency tracking function.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in e limiting sense, and the scope of the present disclosure is defined by the appended claims.

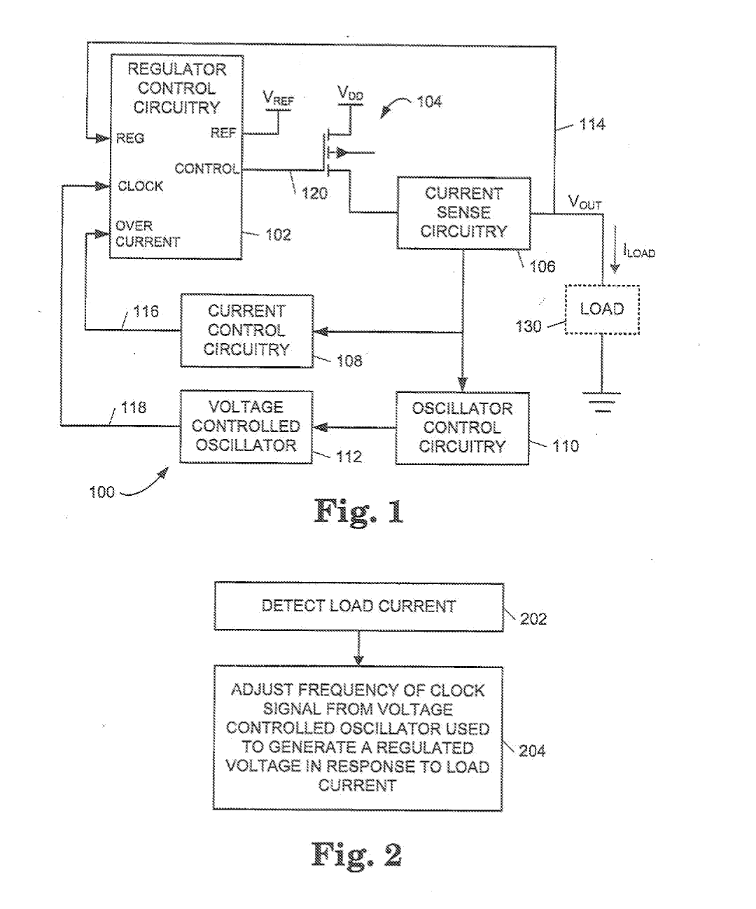

FIG. 1 is a block diagram illustrating one embodiment of a voltage regulator 100 with an efficiency tracking function. Voltage regulator 100 includes regulator control circuitry 102, a transistor 104, current sense circuitry 106, current control circuitry 108, oscillator control circuitry 110, and a voltage controlled oscillator (VCO) 112.

Voltage regulator 100 provides a regulated voltage signal 114 (V_{OUT}) to a load 130 using a reference voltage (V_{REF}) and a supply voltage (V_{DD}). Voltage regulator 100 operates to provide regulated voltage signal 114 at as constant of an output voltage as possible regardless of the amount of current drawn by load 130 or operating frequency of load 130.

Voltage regulator 100 implements an efficiency tracking function to maximize the power efficiency of voltage regulator 100. As used herein, the term power efficiency refers to the ratio of the amount of power output to load 130 by voltage regulator 100 to the amount of power drawn by voltage regulator 100 in generating and providing the output voltage and the output current to load 130. The power efficiency of voltage regulator 100 varies in response to the frequency of a clock signal 118 used to generate regulated voltage signal 114 and the amount of current provided to the load. Accordingly, voltage regulator 100 tracks the current load drawn by load 130 and modifies the operating frequency of clock signal 118 provided to regulator control circuitry 102 to optimize the efficiency of regulator 100 for the current load. Voltage regulator 100 generates regulated voltage signal 114 using a feedback signal that is separate from clock signal 118 and corresponds to the output voltage.

In voltage regulator 100, regulator control circuitry 102 receives the reference voltage at a REF input, a feedback signal (i.e., regulated voltage signal 114 in the embodiment of FIG. 1) at a REG input, clock signal 118 at a CLOCK input, and an over current signal 116 at an OVER CURRENT input. Regulator control circuitry 102 includes digital combinatorial logic circuitry that is driven by clock signal 118 to generate control signal 120 responsive to the reference voltage, the feedback signal, and over current signal 116. Regulator control circuitry 102 generates control signal 120 to cause the output voltage on regulator output signal 114 to be adjusted by transistor 104 and maintained at a desired constant output voltage level. Regulator control circuitry 102 outputs control signal 120 at a CONTROL output.

The power efficiency of regulator control circuitry 102 in generating control signal 120 varies In response to the frequency of clock signal 118 and the amount of current provided to the load. Thus, the power efficiency of regulator control circuitry 102 may be adjusted by adjusting the frequency of clock signal 118.

The feedback signal provided to the REG input of regulator control circuitry 102 corresponds to the output voltage on regulated voltage signal 114 and is separate from and independent of clock signal 118. In one embodiment, the feedback signal is the analog output voltage on signal 114. In other embodiments, the feedback signal is otherwise determined or derived from the analog output voltage on signal 114 and may be converted to a digital input prior to being provided to regulator control circuitry 102.

Transistor 104 is a MOSFET or other suitable transistor configured to receive the supply voltage (V_{DD}) at the source terminal and control signal 120 at the gate terminal. Transistor 104 generates regulated voltage signal 114 at the drain terminal in response to the supply voltage and control signal 120 and outputs regulated voltage signal 114 to load 130. In other embodiments, transistor 104 may have other suitable configurations for generating regulated voltage signal 114 in response to the supply voltage and control signal 120.

Current sense circuitry 106 receives regulated voltage signal 114 and detects an amount of current provided by voltage regulator 100 to load 130 (i.e., the current load). Current sense circuitry 106 provides at least one output signal to current control circuitry 108 and oscillator control circuitry 110 that identifies the current load. Current sense circuitry 106 may determine the current load and provide the output signal continuously, periodically, or responsive to a control input (not shown). Current sense circuitry 106 includes any suitable analog or digital circuitry configured to determine the current load and provide the output signal.

Current control circuitry 108 provides over current signal 116 to regulator control circuitry 102 responsive to the one or more signals from received from current sense circuitry 106 that identify the current load drawn by load 130. Over current signal 116 indicates whether the amount of current drawn by load 130 exceeds a threshold current level. Current control circuitry 108 may generate and provide over current signal 116 continuously, periodically, or responsive to a control input (not shown). Current control circuitry 108 includes any suitable analog or digital circuitry configured to implement a transfer function that outputs over current signal 116 to Indicate to regulator control circuitry 102 whether the amount of current drawn by load 130 exceeds a threshold current level.

Oscillator control circuitry 110 provides one or more voltage control signals to VCO 112 responsive to the one or more signals from received from current sense circuitry 106 that identify the current load drawn by load 130. The voltage control signal or signals are Configured to adjust the frequency of clock signal 118 by controlling the voltage used by VCO 112 to generate clock signal 118. Oscillator control circuitry 110 may generate and provide the voltage control signal or signals continuously, periodically, or responsive to a control input (not shown). Oscillator control circuitry 110 includes any suitable analog or digital circuitry configured to implement a transfer function that outputs the voltage control signal or signals at voltage levels that correspond to current loads of load 130. The transfer function may operate using stored information such as a table that provides a voltage control signal level for each current load or range of current loads. The transfer function implemented by oscillator control circuitry 110 is designed to set the frequency of clock signal 118 at a point where the power efficiency of voltage regulator 100 is at a maximum for the current load detected by current sense circuitry 106.

VCO 112 generates and outputs clock signal 118 with a constant duty cycle (i.e., fixed pulse width at each frequency) at a frequency that varies in dependence on the voltage control signal or signals received from oscillator control circuitry 110. The duty cycle of clock signal 118 may be 50% or another suitable constant duty cycle. VCO 112 provides clock signal 118 to regulator control circuitry 102.

Load 130 represents any suitable electronic device or set of devices configured to operate with a constant input voltage and draw a load current. Load 130 is shown with dashed lines in FIG. 1 to indicate that it is separate from voltage regulator 100. Load 130 may draw relatively constant or varying amounts of current from voltage regulator 100 over time.

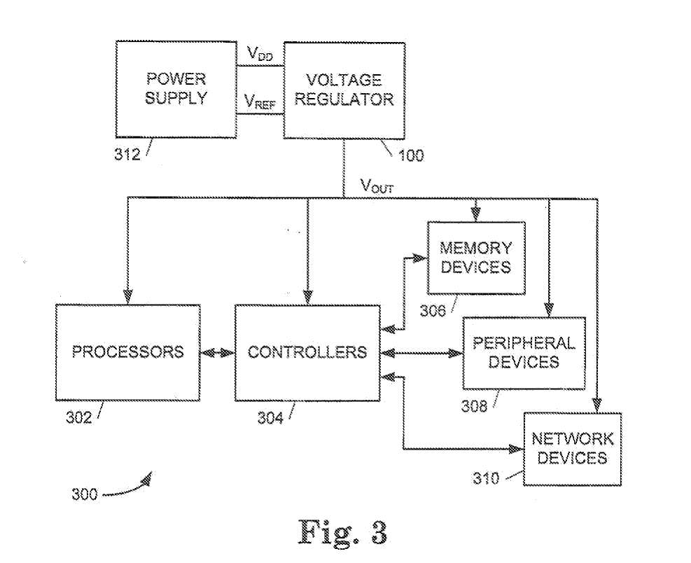

FIG. 2 is a flow diagram illustrating one embodiment of a method for operating a voltage regulator to implement an efficiency tracking function. The method of FIG. 2 will be described with reference to the embodiment of voltage regulator 100 in FIG. 1.

In the embodiment of FIG. 2, voltage regulator 100 detects a load current provided to a load as indicated in a block 202. As described above, current sense circuitry 106 is configured to perform this function in one embodiment.

Voltage regulator 100 adjusts a frequency of a clock signal from a VCO that is used to generate a regulated voltage in response to the load current as indicated in a block 204. Oscillator control circuitry 110 adjusts the frequency of clock signal 118 in response to the current load detected by current sense circuitry 106. Regulator control circuitry 102 uses clock signal 118 to generate control signal 120 which controls the operation of transistor 104 to output the regulated voltage.

FIG. 3 is a block diagram illustrating one embodiment of a processing system 300 that includes voltage regulator 100 (shown in FIG. 1) with the efficiency tracking function. Processing system 300 includes voltage regulator 100, one or more processors 302, one or more controllers 304, one or more memory devices 306, one or more peripheral devices 308, one or more network devices 310, and a power supply 312.

Processing system 300 may form any suitable processing device configured for a general purpose or a specific purpose. Examples of processing system 300 include a server, a personal computer, a laptop computer, a tablet computer, a personal digital assistant (PDA), a mobile telephone, and an audio/video device. Voltage regulator 100, processors 302, controllers 304, memory devices 306, peripheral devices 308, network devices 310, and power supply 312 may be contained in a common housing (not shown) or in separate housings (not shown) and may be interconnected using any suitable combination of wired and/or wireless connections.

Voltage regulator 100 provides a regulated voltage (V_{OUT})to one or more of processors 302, controllers 304, memory devices 306, peripheral devices 308, and/or network devices 310. In other embodiments, additional voltage regulators 100 may be included in processing system 300 to provide a regulated voltage to other sets of processors 302, controllers 304, memory devices 306, peripheral devices 308, and/or network devices 310. Voltage regulator 100 implements an efficiency tracking function to maximize the power efficiency of voltage regulator 100 as described above with reference to FIGS. 1 and 2. Accordingly, voltage regulator 100 may increase the power efficiency of processing system 300 when compared to other voltage regulators.

Power supply 312 is any suitable AC and/or DC power source configured to provide a reference voltage (V_{REF}) and a supply voltage (V_{DD}) to voltage regulator 100.

Processors 302 are configured to access and execute instructions stored. in memory devices 306 using controllers 304. The instructions may include a basic input output system (BIOS), firmware, an operating system that provides a library of functions to application programs, and/or application programs. Each processor 302 may execute the instructions in conjunction with or in response to peripheral devices 308 and/or network devices 310.

Controllers 304 include any suitable type and/or number of controllers configured to control the operation of memory devices 306, peripheral devices 308, and/or network devices 310 in conjunction with processors 302. Controllers 304 also operate to transfer information between processors 302 and memory devices 306, peripheral devices 308, and network devices 310.

Memory devices 306 include any suitable type and/or number of volatile or non-volatile storage devices configured to store instructions and other information. Processors 302, controllers 304, peripheral devices 308, and network devices 310 may store information to or retrieve information from memory devices 306.

Peripheral devices 308 include any suitable type and/or number of configured to operate with one or more other devices in processing system 300. Peripheral devices 308 may include input/output devices or other devices configured to perform specified processing functions.

Network devices 310 include any suitable type and/or number of network devices configured to allow processing system 300 to communicate across one or more external networks (not shown). Network devices 310 may operate according to any suitable networking protocol and/or configuration to allow information to be transferred from processing system 300 across a network or to processing system 300 from a network.

Although specific embodiments have been illustrated and described herein for purposes of description of the embodiments, it will be appreciated by those of ordinary skill in the art that ,a wide variety of alternate and/or equivalent implementations may be substituted for the specific embodiments shown and described without departing from the scope of the present disclosure. Those with skill in the art will readily appreciate that the present disclosure may be implemented in a very wide variety of embodiments. This application is intended to cover any adaptations or variations of the disclosed embodiments discussed herein. Therefore, it is manifestly intended that the scope of the present disclosure be limited by the claims and the equivalents thereof.

What is claimed is:

1. A voltage regulator comprising:
current sense circuitry configured to detect an amount of current provided to a load;
a voltage controlled oscillator configured to output a clock signal with a constant duty cycle at a frequency that varies in dependence on the amount of current detected by current sense circuitry; and
regulator circuitry configured to provide a regulated voltage to the load using the clock signal.

2. The voltage regulator of claim 1 wherein the regulator circuitry is configured to generate the regulated voltage using a feedback signal that is separate from the clock signal.

3. The voltage regulator of claim 1 further comprising:
oscillator control circuitry configured to control the frequency of the clock signal output by the voltage controlled oscillator in response to the amount of current detected by the current sense circuitry.

4. The voltage regulator of claim 3 wherein the oscillator control circuitry is configured to control the frequency of the clock signal continuously.

5. The voltage regulator of claim 3 wherein the oscillator control circuitry is configured to control the frequency of the clock signal periodically.

6. The voltage regulator of claim 3 herein the oscillator control circuitry is configured to adjust the frequency of the clock signal using stored information.

7. The voltage regulator of claim 1 wherein a power efficiency of the regulator circuitry varies in response to the frequency of the clock signal and the amount of current provided to the load.

8. The voltage regulator of claim 1 wherein the regulator circuitry includes regulator control circuitry and a transistor, wherein the regulator control circuitry is configured to provide a control signal to the transistor, and wherein the transistor is configured to output the regulated voltage in accordance with the control signal.

9. The voltage regulator of claim 8 wherein the regulator control circuitry is configured to generate the control signal using the clock signal and a feedback signal that corresponds to the regulated voltage.

10. The voltage regulator of claim 8 further comprising:
current control circuitry configured to provide an over current signal to the regulator control circuitry in response to detecting that the amount of current exceeds a threshold current level.

11. A method comprising:
detecting an amount of current provided from a voltage regulator to a load;
adjusting a frequency of a fixed pulse width clock signal in accordance with the load; and
generating a regulated voltage in the voltage regulator in response to the clock signal.

12. The method of claim 11 further comprising:
generating the regulated voltage using a feedback signal that corresponds to the regulated voltage and is separate from the clock signal.

13. The method of claim 11 further comprising:
continuously detecting the amount of current provided from the voltage regulator to the load; and
continuously adjusting the frequency of the fixed pulse width clock signal in accordance with the load.

14. The method of claim 11 further comprising:
periodically detecting the amount of current provided from the voltage regulator to the load; and
periodically adjusting the frequency of the fixed pulse width clock signal in accordance with the load.

15. The method of claim 11 further comprising:
generating a control signal using the clock signal and a feedback signal that corresponds to the regulated voltage; and
providing the control signal to a transistor configured to generate the regulated voltage.

16. A system comprising:
a device;
a voltage regulator configured to provide a regulated voltage to the device; and
a power supply configured to provide power to the voltage regulator;
wherein the voltage regulator is configured to detect an amount of current provided to the device, adjust a frequency of a constant duty cycle clock signal generated by a voltage controlled oscillator in dependence on the amount of current, and generate the regulated voltage using the clock signal.

17. The system of claim 16 wherein the voltage regulator is configured to generate the regulated voltage using a feedback signal that is separate from the clock signal.

18. The system of claim 16 wherein the voltage regulator is configured to adjust the frequency of the clock signal continuously.

19. The system of claim 16 wherein the voltage regulator is configured to adjust the frequency of the clock signal periodically.

20. The system of claim 16 wherein a power efficiency of the voltage regulator varies in response to the frequency of the clock signal and the amount of current provided to the device.
